(19) United States
(12) Patent Application Publication
(10) Pub. No.: US 2008/0096991 A1
(43) Pub. Date: Apr. 24, 2008

(54) Treated expanded polystyrene foam

(76) Inventors: Navnit Bhuleshwar Upadhyay, Presto, PA (US); Theodore Alan Grant, Grand Rapids, MI (US)

Correspondence Address: LANXESS CORPORATION, 111 RIDC PARK WEST DRIVE, PITTSBURGH, PA, 15275-1112, US

(21) Appl. No.: 11/584,119

(22) Filed: Oct. 20, 2006

(51) Int. Cl. C08J 9/22

(52) U.S. Cl. 521/57

(57) ABSTRACT

Expanded polystyrene coated with at least one organic pesticide, methods for making expanded polystyrene coated with at least one organic pesticide, and molded articles made from expanded polystyrene coated with at least one organic pesticide is provided herein.

### FIELD OF THE INVENTION

The present invention relates to expanded polystyrene foams that have been treated with at least one organic compound and methods for preparing the same.

### BACKGROUND

Polystyrene is generally formed by the polymerization of styrene monomers to form chains of from 150,000 AMU to 400,000 AMU long that coalesce into small round beads when suspended in an aqueous phase and agitated under pressure. The speed of the agitation helps to control the size of the beads with a common target size of around 1 mm. During polymerization and bead formation, small seed particles of, for example, talc, are distributed throughout strings of polystyrene and become trapped in the beads creating microvoids within the beads. These microvoids become sites wherein volatile compounds, such as, pentane or carbon dioxide, commonly referred to as “blowing agents”, are held. The resulting polystyrene beads are on average about 0.85-mm in diameter (a little over 1/32^{nd}-inch or about the size of beach sand) and contain tens of thousands of microcells of interlaced polystyrene walls containing captured blowing agent that are “expandable” with further processing. Accordingly, these polystyrene beads are commonly referred to as “expandable polystyrene resin”.

Expandable polystyrene resin may be processed by heating to form “expanded polystyrene” or “EPS”. During processing, the expandable polystyrene resin is subjected to temperatures that exceed the boiling point of the blowing agent encapsulated in the expandable polystyrene resin at which point the expandable polystyrene resin expands. The EPS may than be molded into various shapes through treatment with heat and pressure which cause the EPS to fuse forming a solid foam.

Polystyrene foams are generally tough, lightweight, and resistant to degradation and have many common uses such as, insulation, for example in refrigerators and coolers; packing material, such as foam “peanuts”; and shaped foam padding used for example, in packing electronics; and recently, building and structural materials, such as, in-foam board insulation and structural insulated panels. These uses may require the polystyrene foams to come into contact with common pests, such as, insects, termites, beetles, fungi, mold, mildew, bacteria and the like. Accordingly, a need has arisen for polystyrene foams that are resistant to common pests that may otherwise damage the polystyrene foam itself, underlying materials such as wood, or plastic, or the environment surrounding the foam.

Recently, pesticides have been used to treat expandable polystyrene foam (EPS) building products that come in contact with structural wood, such as, insulation, and particularly EPS board insulation. JP 63-152648, JP 63-159451, JP 63-254143, and JP 63-264670 describe the use of various active agents including organophosphorus based chloropyrifos, carbamate agents, fenitrothion, phoxim and boron containing compounds such as boric acid and it's salts. In each of these, the active agent is mixed with an adhesive and a mixture of expanded polystyrene beads that is heated to form a shaped solid.

U.S. Pat. No. 5,149,726 describes an extruded polystyrene board that resists boring insects based on the density and cell dimensions of the polystyrene foam.

U.S. Pat. Nos. 5,194,323, 5,270,108, 5,373,674, and 5,598,677 disclose structural building panels having fungal and insect resistant properties that are treated with sodium borate. However, sodium borate salt may be corrosive and abrasive making them deleterious to machinery used in production of the foam. Moreover, a relatively large dose of sodium borate may be required for effective insecticide activity, and sodium borate is water soluble. Therefore, the sodium borate may leach out of treated foam that comes into contact with water, into soil or standing water and may become toxic to children, small animals, pets, and fish. Additionally, high borate concentrations may produce corrosive and toxic gases when burned.

U.S. Pat. No. 5,704,172 teaches scoring of EPS board with grooves, which in turn would facilitate the application of insecticides.

U.S. Pat. Nos. 6,033,731 and 6,080,796 describe the impregnation of expandable polystyrene beads with an insecticide. When the beads are expanded, a large portion of the insecticide remains within the bead, and the insecticide material near the surface of each expandable bead appears to be most effective at repelling insects. Accordingly, impregnating insecticides within expandable beads may require as much as 50 to 100 times more insecticide than may otherwise be required to achieve an effective amount.

Accordingly, there is a need for expanded polystyrene and molded articles made therefrom that effectively repels pests using a relatively low dose of a pesticide. Moreover, a need exists for such expanded polystyrene that is resistant to leaching out of a pesticide into the surrounding environment, and has a long use life.

### SUMMARY

Embodiments of the invention presented herein may include a coated polystyrene including an expanded polystyrene having at least one organic compound operably bound to an outer surface of the expanded polystyrene and substantially coating the outer surface of the expanded polystyrene. Organic compounds of embodiments may be operably bound to the expanded polystyrene through an electrostatic interaction and may be selected from pesticides, insecticides, termiticides, fungicides, moldicides, bactericides, mildewicides, and combinations thereof in any form including, but not limited to, a powder, a liquid, an emulsion, and an immiscible concentrate. In certain embodiments, the organic compound may be a termiticide and in others, the organic compound may be imidacloprid or imidiclopric containing mixtures. In embodiments, the organic compound may be provided in sufficient concentration to destroy pests that come into contact with the coated expanded polystyrene, and the concentration of the organic compound may be from about 0.01 wt/vol. % to about 1.0 wt/vol. % of the expanded polystyrene or about 0.01 wt/vol. % to about 0.15 wt/vol. % of the expanded polystyrene. In some embodiments, the expanded polystyrene may be prepared from expandable polystyrene 10 beads. In embodiments, the expanded polystyrene may substantially resist pests, and in others, the expanded polystyrene may substantially resist termites.

Other embodiments of the invention include a method including contacting expandable polystyrene with at least one organic compound in a concentration sufficient to coat an outer surface of the expandable polystyrene when expanded, mixing the at least one organic compound with the expandable polystyrene to form a mixture, and exposing the mixture to conditions such that the expandable polystyrene expands to form a coated expanded polystyrene. In some embodiments, exposing the expandable polystyrene to conditions such that the expandable polystyrene expands includes adding heat and, optionally, pressure to the mixture. In other embodiments, the organic compound may become operably bound to the expandable polystyrene during expansion, and in certain embodiments, the organic compound may become operably bound to the expandable polystyrene through an electrostatic interaction when expansion of the expandable polystyrene is induced. Organic compounds of embodiments may include pesticides, insecticides, termiticides, fungicides, moldicides, bactericides, mildewicides, and combinations thereof, and may be in any form such as, but not limited to, powder, liquid, emulsion, or immiscible concentrate. In certain embodiments, the method of embodiments may further comprise preparing a molded article from the coated expanded polystyrene.

Other embodiments are directed to an expanded polystyrene molded article prepared by the method including contacting expandable polystyrene with at least one organic compound in a concentration sufficient to coat an outer surface of the expandable polystyrene when expanded, mixing the at least one organic compound with the expandable polystyrene to form a mixture, exposing the mixture to conditions such that the expandable polystyrene expands to form a coated expanded polystyrene, and preparing a molded article from the coated expanded polystyrene. Organic compounds of embodiments may be operably bound to the expanded polystyrene through an electrostatic interaction and may be selected from pesticides, insecticides, termiticides, fungicides, moldicides, bactericides, mildewicides, and combinations thereof in any form including, but not limited to, powder, liquid, emulsion, or immiscible concentrate. In certain embodiments, the organic compound may be a termiticide and in others, the organic compound may be imidacloprid or imidiclopric containing mixtures. In some embodiments the molded article prepared may be substantially resistant to pests, and in others, the molded article may be substantially resistant to termites. In still other embodiments, the molded article may be selected from polystyrene insulation, polystyrene foam board, polystyrene foam packaging, and polystyrene foam coatings.

### DESCRIPTION OF DRAWINGS

For a fuller understanding of the nature and advantages of the present invention, reference should be made to the following detailed description taken in connection with the accompanying drawings, in which:

FIG. 1 illustrates a flow chart of an embodiment of a method whereby treated expanded polystyrene may be prepared.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “bead” is a reference to one or more beads and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. Nothing herein is to be construed as an admission that the invention is not entitled to antedate such disclosure by virtue of prior invention.

The methods as described herein for use contemplate prophylactic use as well as curative use in therapy of an existing condition. As used herein, the term “about” means plus or minus 10% of the numerical value of the number with which it is being used. Therefore, about 50% means in the range of 45%-55%.

An “effective amount” of a composition is a predetermined amount calculated to achieve the desired effect, i.e., to effectively deter the infestation of manufactured material from one or more pest. Effective amounts of compounds of the present invention can be measured by the ability of the compound to deter pest infestation, movement, and destruction of manufactured materials or underlying materials.

It will be further understood that in the ensuing description and claims the term “pesticide” is interchangeable with and encompasses “insecticide”, “termiticide”, “fungicide”, “moldicide”, “mildewicide”, “bactericide” and the like and are distinguishable only by evidence that a compound is more effective at repelling, killing, or preventing the growth of insects, termites, fungi, mold, mildew, and bacteria, respectively.

Embodiments of the invention described herein may generally include expanded polystyrene (hereinafter “EPS”) coated with at least one organic pesticide, manufactured products made from such expanded polystyrene, and methods for producing the expanded polystyrene foams. By “expanded polystyrene” is meant EPS prepared by any method known in the art including, but not limited to, expansion steam treatment and extrusion. The coated EPS and molded articles prepared using coated EPS of embodiments resist infestation from common pests such as, for example, insects, termites, beetles, fungi, mold, mildew, bacteria, and the like, and provide a barrier to infestation from such pests of underlying materials such as wood, plastic, or composite materials.

“Treated” or “coated EPS” of embodiments may generally include an outer surface that is substantially covered by an organic pesticide. In some embodiments, an organic pesticide may contact expandable polystyrene resins prior to expansion processing wherein heat is applied to the expandable polystyrene resin initiating expansion to create a coated EPS. In other embodiments, the organic pesticide may contact the EPS following expansion wherein individual EPS beads may be coated with the organic pesticide prior to molding wherein the EPS attains its final form. In still other embodiments, molded EPS may be contacted with an organic pesticide wherein the outer surface of the molded EPS may be coated with the organic pesticide.

Contacting expandable polystyrene resin and/or EPS and/or molded EPS may occur through any method known in the art. For example, in some embodiments, a powder or immiscible concentrate of an organic pesticide may be mixed with expandable polystyrene resins or EPS, and in others, a liquid or emulsion of an organic pesticide may be sprayed onto an expandable polystyrene resin, EPS, or molded EPS.

Organic pesticides may be any organic pesticide known in the art and may be in any form including, but not limited to, powders, liquids, emulsions, and immiscible concentrates in various embodiments. In certain embodiments, more than one organic pesticide may be combined and used to make coated EPS beads. The weight to volume ratio of organic pesticide to EPS in the final molded EPS may vary between embodiments. Preferably, organic pesticide may be used at a sufficient concentration to coat an outer surface of each of the EPS beads in a molded article with organic pesticide. Therefore, the concentration of organic pesticide may vary depending on the size and concentration of EPS in a molded article. In some embodiments, the concentration of organic pesticide may be from about 0.01 wt/vol % to about 1.0 wt/vol % in the final molded article, and in others, the concentration may be from about 0.01 wt/vol % to about 0.15 wt/vol % or about 0.08 wt/vol % in the final molded article. Without wishing to be bound by theory, the concentration of organic pesticides in molded articles made from coated EPS may be much lower than other inorganic pesticides used in prior art because less pesticide may be necessary to coat the EPS beads than to fill them.

Organic pesticides may operably bind to EPS beads more readily than inorganic salts, such as sodium borate. Without wishing to be bound by theory, binding of the organic pesticide to the EPS may be achieved during the expansion process wherein the expandable polystyrene resin may soften during heating. An electrostatic interaction, such as, for example, hydrogen bonding, may occur between polystyrene monomers and molecules of the organic pesticide, or water from the steam used to heat the expandable polystyrene resin may act as a carrier bringing molecules of the organic pesticide into close proximity with polystyrene monomers allowing an electrostatic interaction to occur between these moieties. No such interactions may occur when inorganic pesticides are brought into contact with expanding EPS beads, and the inorganic pesticide may bind to the bead by much weaker interactions which may allow the coating to be lost during processing and may interfere with fusion during the molding process. Furthermore, an electrostatic interaction between an organic pesticide and one or more EPS beads may allow fusion of EPS beads to occur more readily during molding, and may actually enhance the physical properties of the final molded article.

The service life of molded articles made using EPS coated with an organic pesticide may be significantly improved over similar molded articles prepared using inorganic pesticide. Without wishing to be bound by theory unlike inorganic salts, organic pesticides may not be soluble in water, and organic pesticides used in molded articles prepared from coated EPS may not be susceptible to leaching which is observed with inorganic pesticides. Therefore, molded articles prepared with organic pesticide coated EPS exposed to water may retain their pesticidal activity more readily than similar articles prepared with inorganic articles.

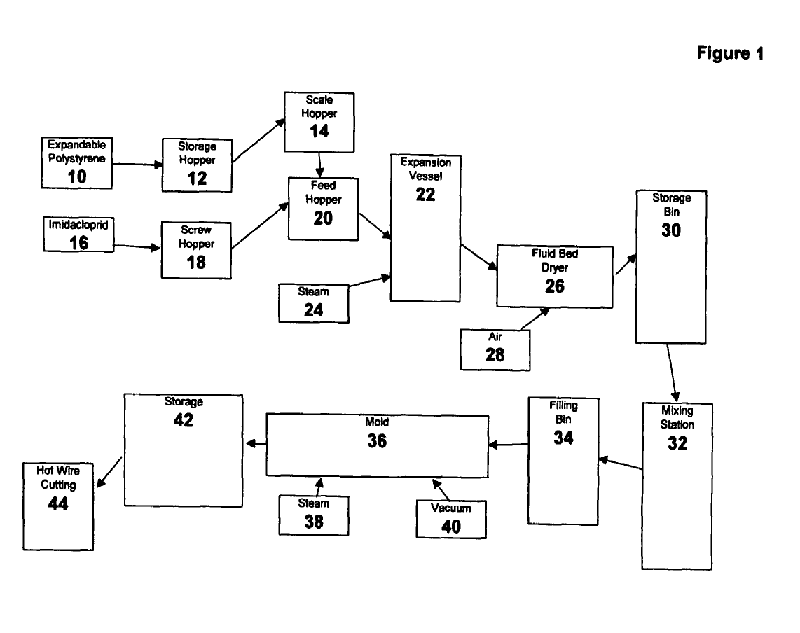

A molded article prepared from coated EPS may be obtained, for example, as illustrated in FIG. 1. Expandable polystyrene resin 10 may be placed in a storage hopper 12 and maintained there until use at which time an appropriate amount of the resin 10 may be metered out, for example, using a scale hopper 14 and conveyed into a feed hopper 20 or other storage unit. Similarly, an organic pesticide 16 may be placed into a unit suitable for measuring out a specific predetermined amount of the pesticide 16, such as, a screw hopper 18 having sensors that detect when an appropriate amount of the pesticide 16 has been removed from the hopper 18, and this amount of the pesticide 16 may be conveyed into a feed hopper 20 where it may be mixed with expandable polystyrene resin 10. An appropriate amount of resin 10 and organic pesticide may be any amount necessary to produce the desired weight to volume ratio of organic pesticide 16 in a molded article having a desired density. The skilled artisan may determine the density (usually in pounds-per-cubic-feet) of the final molded article based on the amount (weight) of resin 10 provided and may use this to determine a predictable concentration of organic pesticide 16 to EPS (weight to volume) ratio in the final molded article. For example, about 0.80 lbs of an organic pesticide, such as, for example, imidacloprid, can be equally distributed over about 1000-ft³ of EPS.

The expansion of the expandable polystyrene resin 10 may begin when the combined expandable polystyrene resin 10 and organic pesticide 16 in the feed hopper 20 is moved into an expansion vessel 22 where a mixing apparatus, such as paddles, may be used to mix the expandable polystyrene resin 10 and organic pesticide 16 until the expandable resin 10 and the organic pesticide 16 are suitably mixed. Once mixed, steam 24 may be metered into the expansion vessel 22 while agitation of the expandable resin 10 and the organic pesticide 16 may be maintained to induce expansion of the expandable polystyrene resin. As the temperature within the expansion vessel 22 rises to above the boiling point of the blowing agent, the expandable polystyrene resin 10 may begin to expand, and at the same time, the organic pesticide 16 may begin to closely associate or adhere to the expanding polystyrene resin 10. Steam 24 may continue to be metered into the expansion vessel and may continue to drive expansion of the expandable resin until the resin has expanded to a predetermined size, such as, for example, an average diameter of up to about 3.0 mm, or a suitable density of the EPS has been reached, for example, about 44 times the original density. In some embodiments, the resin diameter or EPS density may be determined based on a polymer volume within the expansion vessel 22, and once the predetermined volume has been reached, the steam pressure may be reduced. The coated EPS formed by this process may then move from the expansion vessel 22 into a unit suitable for cooling and drying the coated EPS, such as, a fluid bed dryer 26.

Within the fluid bed dryer 26 warm air 28 may be passed through the coated EPS allowing it to cool to below its softening point of the resin 10. At the same time, residual blowing agent may be cooled to below its boiling point which may halt the expansion of the resin 10, and water from the steam 24 in the expansion vessel 22 that may have condensed on the coated EPS may be dried. The organic pesticide 16 may be well attached to the EPS, preventing loss of organic pesticide 16 during the cooling/drying process. Moreover, the amount of residual pesticide 16 may be limited, preventing residual pesticide from clogging of air vents in the fluid bed dryer 26. Upon reaching the end of the fluid bed dryer 26, the coated EPS may have hardened and may be conveyed to storage bins. In some embodiment, the coated EPS may be conveyed from the fluid bed dryer 26 to storage bins 30 via air stream in ducts. Again, the association of the organic pesticide 16 for the EPS is such that the coated EPS may be conveyed by any means known in the art without damage or substantial loss of the organic pesticide coating 16. The storage bins 30 of embodiments may be netted, being constructed of fabric which allows exchange with the atmosphere outside the storage bins 30, and may typically be large enough to hold 1000 to 5000 cubic feet of coated EPS. Since the pesticide 16 may be substantially bound to the expanded bead, clogging of the fabric pores may not occur.

The coated EPS may be aged within the storage bins 30. During the aging process, coated EPS may be further cooled and residual blowing agent may condense back to liquid forming a partial negative pressure. Through diffusion with fresh air into the cells, the pressure may equalize, and excess blowing agent may slowly diffuse from the EPS beads. This aging process may require from 3 hrs to 4 days for completion depending on the blowing agent used in the expandable polystyrene resin 10, the density of the coated EPS, and various other factors. When the coated EPS has been sufficiently aged, it may be transferred from storage bin 30 to mixing station 32 where the coated EPS may optionally be combined with recycled polystyrene material, other expanded beads, or other materials. The coated EPS may then be transferred from the mixing station 32 to the filling bin 34 where it may be stored until used to fill a mold 36.

During filling, coated EPS may be transferred directly from the filling bin to a mold 36, and vacuum 40 may be applied through small slits or holes in the plates that form an interior of a mold 36. The application of vacuum 40 may ensure that the mold 36 is completely packed with coated EPS. Vacuum 40 may continue to be applied from one side of the mold 36 following filling, and steam 38 may be slowly introduced from another side of the mold 36 creating a process commonly referred to as “cross rinsing”. During cross-rinsing, the rate at which steam is introduced into the mold 36 may be controlled and the direction from which the steam 38 enters the mold 36 may be switched which may allow steam to permeate and heat the entire mold cavity without “baking” the outside material. As cross-rinsing continues, air from the spaces between the coated EPS beads may be removed and heat from the steam 38 may soften the polystyrene beads while residual blowing agent may boil off. The coated EPS may begin to expand against adjacent beads and against the plates of the mold 36 increasing the pressure within the mold cavity. When the pressure reaches a suitable level the vacuum 40 may be stopped. The softened coated individual beads of EPS may continue to be pressed together as expansion continues and may begin to form into a combined mass the shape of the mold cavity.

Molds 36 of embodiments may be of any size or shape and may allow the coated EPS to take on any imaginable shape. For example, a mold 36 can be a large cavity wherein blocks, for example, 33″×48″×288″ may be made, or a mold may be shaped to produce a distinct rigid product which may be used to pad electronics during shipping, or to fill specific cavities, such as scalloped filler to support vinyl siding, or specifically fill a space and provide insulation in a cooler or refrigerator.

Without wishing to be bound by theory whereas inorganic salts may act as a “powder coat” that may interfere with fusion of EPS beads, organic pesticide may actually help coated EPS beads fuse preserving or enhancing the physical strength and integrity of the rigid products made using this process.

As the coated EPS continues to expand and fuse, the pressure within the mold 36 may continue to increase and product formation can be determined using the internal pressure of the mold. Once the desired product pressure is reached, the introduction of steam 38 may be stopped and vacuum 40 again may be applied to the mold 36 cavity. The pressure may then be allowed to drop to about zero while the fused coated EPS is cooled. Once the pressure has equalized and the fused coated EPS is sufficiently cooled, the mold 36 may be opened and the molded article may be removed from the mold and stored 42 to allow curing.

Curing may continue for any amount of time, for example, about 1 to about 5 days, until the molded article attains dimensional stability while any residual blowing agent and/or moisture may diffuse away from the molded article. Following curing, the molded article may be used directly or processed further. For example, blocks of molded, coated EPS may be cut into sheets or other shapes using hot wire cutters 44 or the surface of the molded article may be smoothed.

The above example represents a single embodiment of the disclosed invention, and embodiments of the invention should not be limited to those described above. In embodiments, any method controlled metering of the dry chemical into the manufacturing of EPS may be employed. For example, a continuous expansion system may be used instead of the batch method described herein.

Advantageously, the use of organic pesticides may improve the service life and performance of equipment used in the process described above over inorganic pesticides because inorganic salts used as pesticides may have a deleterious effect on equipment made of metal. Accordingly, the hot wire cutters 44, molds 36, and the like, may have longer service lives and produce better final products when used in a process utilizing organic pesticides. Moreover, the interaction between an organic pesticide and an EPS may be significantly better than the interaction between an inorganic pesticide and an EPS allowing an organic pesticide coating to remain adhered to the EPS during processing. Therefore, clogs in pores of equipment such as, fluid bed dryer 26, storage bin 30, mold 36, and the like, over time may be avoided by eliminating the need for some maintenance of these apparatuses.

The organic pesticides of embodiments may be any organic compound known in the art to impart pesticidal activity, or pest repellency to an article treated with the organic compound. For example, organic pesticides may kill, repel or deter growth of insects, termites, beetles, fungi, mold, and/or mildew, and may be referred to as insecticides, termiticides, fungicides, moldicides, mildewicides, or equivalents thereof. In some embodiments, one or more organic compound may be utilized in the manufacture of a molded article having coated EPS. Therefore, in some embodiments, mixtures of two or more organic insecticides, termiticides, fungicide or moldicide, one or more insecticide and one or more fungicide or moldicide, or one or more fungicide and one or more moldicide may be incorporated into an EPS molded article.

Examples of organic insecticides may include, but not be limited to, imidicloprid (1-[(6-chloro-3-pyridinyl)methyl]-4,5-dihydro-N-nitro-1H-imidazol-2-amine), thiacloprid ((Z)-3-(6-chloro-3-pyridylmethyl)-1,3-thiazolidin-2-ylidenecyanamide), fipronil (5-Amino-1-(2,6-dichloro-4-(trifluoromethyl)phenyl)-4-(1,R,S)-(trifluoromethyl)sulfinyl)-1H-pyrazole-3-carbonitrile), clothianidin ((E)-1-(2-chloro-1,3-thiazol-5-ylmethyl)-3-methyl-2-nitroguanidine), thiamethoxam ((EZ)-3-(2-chloro-1,3-thiazol-5-ylmethyl)-5-methyl-1,3,5-oxadiazinan-4-ylidene(nitro)amine), acetamiprid ((E)-N¹-[(6-chloro-3-pyridyl)methyl]-N²-cyano-N¹-methylacetamidine), allethrin ((RS)-3-allyl-2-methyl-4-oxocyclopent-2-enyl(1RS,3RS;1RS,3SR)-2,2-dimethyl-3-(2-methylprop-1-enyl)cyclopropanecarboxylate), bifenthrin (2-methylbiphenyl-3-ylmethyl(1RS,3RS)-3-[(Z)-2-chloro-3,3,3-trifluoroprop-1-enyl]-2,2-dimethylcyclopropanecarboxylate), chlorfenapyr (4-bromo-2-(4-chlorophenyl)-1-ethoxymethyl-5-trifluoromethyl-1H-pyrrole-3-carbonitrile), cyhalothrin ((S)-α-cyano-3-phenoxybenzyl(1R,3R)-3-[(Z)-2-chloro-3,3,3-trifluoropropenyl]-2,2-dimethylcyclopropanecarboxylate), phoxim (0-(α-cyanobenzylideneamino)0,0-diethylphosphorothioate), chloropyriphos (0,0-diethyl-3,5,6-trichloro-2-pyridylphosphorothioate), as well as pyrethroides series insecticides such as permethrin (5-benzyl-3-furylmethyl-3-(2-methoxy-carbonyl-1-propenyl)-2,2-dimethylcyclopropane carboxylate), decamethrin (α-cyano-3-phenoxybenzyl d,1-cis-3-(2,2-dibromovinyl)-2,2-dimethyl cyclopropane carboxylate), cypermethrin (α-cyano-3-phenoxybenzyl(.+-.)cis,trans-3-(2,2-dichlorovinyl)-2,2-dimethylcyclopropanecarboxylate), deltamethrin ((S)-α-cyano-3-phenoxybenzyl(1R,3R)-3-(2,2-dibromovinyl)-2,2-dimethylcyclopropanecarboxylate), tralomethrin ((S)-α-cyano-3-phenoxybenzyl(1R,3S)-2,2-dimethyl-3-[(RS)-1,2,2,2-tetrabromoethyl]cyclopropanecarboxylate), etofenprox (2-(4-ethoxyphenyl)-2-methylpropyl 3-phenoxybenzyl ether), fenvalerate ((RS)-α-cyano-3-phenoxybenzyl(RS)-2-(4-chlorophenyl)-3-methylbutyrate), cyfluthrin (cyano-(4-fluoro-3-phenoxyphenyl)methyl-3-(2,2-dichloroethenyl)-2,2-dimethyl-cyclopropane carboxylate), and the like, and combinations thereof. In other embodiments, the insecticide may be a termiticide, and in certain embodiments, the organic pesticide may be imidacloprid or related compounds as described in U.S. Pat. No. 6,936,624, entitled “Agents for Preserving Technical Materials Against Insects”, filed Jun. 21, 2001, hereby incorporated by reference in its entirety, and emulsions and immiscible concentrates thereof.

Insecticides may be effective against a variety of insects known to colonize, ingest or otherwise cause decay or destruction of manufactured or natural technical materials including, but not limited to, those of the order Isoptera, Mastotermitidae, Kalotermitidae, and the like such as, Kalotermes spp. Cryptotermes spp.; Termopsidae, such as, Zootermopsis spp.; Rhinotermitidae, such as Reticulitermes spp., Heterotermes spp., and Coptotermes spp.; Termitidae, such as, Amitermes spp., Nasutitermes spp., Acanthotermes spp., Mikrotermes spp.; Coleoptera; Lyctidae, such as, Lyctus brunneus; Bostrychidae, such as, Bostrychus capucinus and Dinoderus minutus; Anobiidae, such as, Anobium punctatum, Xyletinus peltatus, Xestobium rufovillosum, and Ptilinus pectinicomis; Cerambycidae, such as, Hylotrupes bajulus, Hesperophanus cinereus, Stromatium fulvum, and Chlorophorus pilosus; Oedemeridae; Serropulpidae; Curculionidae; Seolytida; Platypodidae; Hymenoptera; Siricidae, such as, Sirex spp. and Urocerus spp.; Formicidae, such as, Camponotus spp. and the like.

Examples of organic fungicides, moldicides, and mildewicides, that may be utilized in embodiments of the invention may generally include any biocide such as, but not be limited to, chlorinated biocides, for example, chloroisocyanurates, chlorothalonil (tetrachloroisophthalonitrile), and lithium hypochlorite; brominated biocides, for example, ammonium bromide, BNPD (2-bromro-2-nitropropane-1,3-diol), halogenated hydantoins, DBDCB (1,2-dibromo-2,4-dicyanobutane), DBNPA (2,2-dibromo-3-nitrilopropionamide), and sodium bromide (NaBr); iodine-based biocides, for example, IPBC (3-iodo-2-propynylbutyl carbamate, iodophors, and DIMTS (diiodomethyl-p-tolylsulfone); quaternary ammonium compounds (quats), WSCP (poly(oxyethylene(dimethylminio)ethylene(dimethyliminio)ethylene dichloride); oxazolidines; THPS (tetrakishydroxymethyl phosphonium sulfate; triazines; IRGAROL 1051 (N-cyclopropyl-n′-(1-1-dimethylethyl)-6-methylthio)-1,3,5-triazine-2,4-diamine); DOWICIL 75 (cis-1-(3-chloroallyl)-3,5,7-triaza-1-azoniaadamantane chloride); trisnitro (tris(hydroxymethyl)nitromethane); BIOBAN P1487 (4-(2-nitrobutyl)-morpholine and 4,4′-(2-ethyl-2-nitrotrimethylene)dimorpholine); dithiocarbamates, for example, disodium ethylene bis(dithiocarbamate), potassium dimethyldithiocarbamate, and sodium dimethyldithiocarbamate; folpet (N-(trichloromethylthio)phthalimide); isothiazolinones, for example, BIT (1,2-benzisothiazolin-3-one), CIT/MIT (5-chloro-2-methyl-4-isothiazolin-3-one and 2-methyl-4-isothiazolin-3-one), MIT (2-methyl-4-isothiazolin-3-one), DCOIT (4,5-dichloro-2-n-octyl-4-isothiazolin-3-one), OIT (2-n-octyl-4-isothiazolin-3-one), and BBIT (N-butyl-1,2-benzisothiazolin-3-one); pyridinethiols, for example, ZPT (zinc-2-pyridinethiol-2-oxide) and NPT (sodium-2-pyridinethiol-2-oxide); thiabendazole (2-(4-thiazolyl)benzimidazole); thiocyanates, for example, MBT (methylenebis(thiocyanate)) and TCMTB (2-(thiocyancanomethylthio)benzothiazole); thione (tetrahydro-3,5-dimethyl-2H-1,3,5-thiadiazine-2-thione); PCP (pentachlorophenol); OPP (o-phenylphenol); OBCP (o-benzo-p-chlorophenol), trisclosan ((5-chloro-2,4-dichlorophenoxy)phenol); PCMC (p-chloro-m-cresol) and the like and combinations thereof. Fungicides of embodiments may include, tebuconazole ((RS)-1-p-chlorophenyl-4,4-dimethyl-3-(1H-1,2,4-triazol-1-ylmethyl)pentan-3-ol), propiconazole ((2RS,4RS;2RS,4SR)-1-[2-(2,4-dichlorophenyl)-4-propyl-1,3-dioxolan-2-ylmethyl]-1H-1,2,4-triazole), cyproconazole ((2RS,3RS;2RS,3SR)-2-(4-chlorophenyl)-3-cyclopropyl-1-(1H-1,2,4-triazol-1-yl)butan-2-ol), triadimefon ((RS)-1-(4-chlorophenoxy)-3,3-dimethyl-1-(1H-1,2,4-triazol-1-yl)butan-2-one), triadimenol ((1RS,2RS;1RS,2SR)-1-(4-chlorophenoxy)-3,3-dimethyl-1-(1H-1,2,4-triazol-1-yl)butan-2-ol), tolylfluanid (N-dichlorofluoromethylthio-N′,N′-dimethyl-N-p-tolylsulfamide), dichlofluanid (N-dichlorofluoromethylthio-N′,N′-dimethyl-N-phenylsulfamide), and the like and combinations thereof.

Biocides of some embodiments may generally be organic compounds that actively combat fungi, molds, and mildews known to colonize and feed from manufactured or natural technical materials such as, for example, those of the orders, Neurospora, Saccharomyces, Morchella, Mucor, Rhizopus, Allomyces, Penicillium, Aspergillus, Cladosposium and the like.

In certain embodiments, the organic pesticide may optionally be mixed with one or more organic compounds known to provide EPS with qualities, such as, for example, fire retardants, colorants, binders, anti-static agents, sealants, and the like, and this mixture may be used to coat EPS.

This invention and embodiments illustrating the method and materials used may be further understood by reference to the following non-limiting examples.

### EXAMPLE 1

In the following example the effectiveness of deterring termite attack on an imidacloprid treated EPS and borate treated EPS was tested and these results were compared. All tests were carried out in accordance with the Standard E1-97 Scope 1.1.2 Choice Method (the “two choice test”) as developed by The American Wood-Preservers' Association (“AWPA”), the standard of authority for protecting wood since 1904. Briefly, a negative control, Southern Yellow Pine (SYP), and a test sample, imidacloprid treated EPS, borate treated EPS, or calibration standards of copper chromated arsenic (CCA) treated SYP, were included in each jar housing termites. The termites were than allowed to choose the material on which to feed.

Unless otherwise noted all insecticide concentrations are provided as a wt/vol %, and the units used with the wt/vol. system are pounds per cubic foot.

Test environments for assessing each sample were prepared as follows: Into individual 80 mmD×100 mm high screw cap jars, 150 grams of screened, washed, heat-sterilized silica sand was mixed with 30 ml distilled water. During the test period, the jars were kept at a temperature between 78° F. to 82° F. with lids screwed loosely and moisture content maintained within 2% of the original conditions.

Test samples were cut to 0.25″ thick by 1″ square and conditioned to a constant weight in a drying oven. Non-treated controls of SYP sapwood (typical termite target) were similarly conditioned. One test sample and one SYP control were placed into each jar on their edges on opposite sides touching the moist sand. The test materials included plain EPS, EPS treated with imidacloprid (0.086%), EPS treated with sodium borate (0.5%), and positive controls of SYP sapwood treated with CCA at three concentrations (5%, 10%, & 22%). CCA treated wood samples serve as positive controls to verify that the test has been set up correctly and as calibration standards to compare with other labs running the test. In all, 12 jars were set up for each test material, and 6 jars for each positive control.

Approximately 400 termites were placed into each jar between the test sample and control, with no more than 5% of the termites being soldiers (which do not eat) while the balance were workers (which do eat). The termites selected for the test procedure were, Reticulitermes flavipes, which have a very broad geographic distribution in eastern North America and thus are representative of a large region of interest. Testing was conducted for 28 days, and the test samples and controls were examined for damage and the termite populations checked for survival.

The identity of the test materials and the results of this test are presented in Table 1.

TABLE 1

| | Con- | Termite | Termite | |
|---|---|---|---|---|
| Test Sample | centration | Damage | Damage | Termite |
| Description | of Additive | Test Sample | Control Sample | Survival |
| Non-treated | 0% | Heavy Attack | Heavy Attack | 85% |
| SYP | | | | |
| Non-treated | 0% | Heavy Attack | Heavy Attack | 85% |
| EPS | | | | |
| Sodium Borate | 0.5% | Moderate | Heavy Attack | 60% |
| treated EPS | | Attack | | |
| Imidacloprid | 0.086% | Light Attack* | Light Attack* | 0%* |
| treated EPS | | | | |
| CCA treated | 5% | Light Attack | Moderate | 25% |
| SYP | | | Attack | |
| CCA treated | 10% | Light Attack | Moderate | 40% |
| SYP | | | Attack | |
| CCA treated | 22% | Light Attack | Heavy Attack | 85% |
| SYP | | | | |

*The E1-97 method does not have a rating for “No Attack”, which was apparent with these samples.

CCA treated SYP performed as expected, validating the test procedure. The imidacloprid treated EPS suffered no damage and caused 100% mortality. It should also be noted that untreated SYP in jars with the imidacloprid also suffered no appreciable damage. In contrast, borate treated EPS showed moderate attack, and the nearby SYP controls were vigorously consumed with many termites surviving the exposure which may be indicative of the slow action of borate treatments. Moreover, at 60% termite survival rate, borate treated EPS did little better than untreated EPS. These results may imply that smaller dose levels of imidacloprid could be used to achieve good performance, and clearly shows that higher levels of borate are needed to achieve equivalent results.

Although the present invention has been described in considerable detail with reference to certain preferred embodiments thereof, other versions are possible. Therefore the spirit and scope of the appended claims should not be limited to the description and the preferred versions contained within this specification.

What is claimed is:

1. A coated expanded polystyrene comprising an expanded polystyrene having at least one organic compound operably bound to an outer surface of the expanded polystyrene and substantially coating the outer surface of the expanded polystyrene.

2. The coated expanded polystyrene of claim 1, wherein the at least one organic compound is selected from pesticides, insecticides, termiticides, fungicides, moldicides, bactericides, mildewicides and combinations thereof.

3. The coated expanded polystyrene of claim 1, wherein the at least one organic compound is a termiticide.

4. The coated expanded polystyrene of claim 1, wherein the at least one organic compound is imidacloprid or imidacloprid containing mixtures.

5. The coated expanded polystyrene of claim 1, wherein the at least one organic compound is in a form selected from a powder, a liquid, an emulsion, and an immiscible concentrate.

6. The coated expanded polystyrene of claim 1, wherein the at least one organic compound is bound to the outer surface of the expanded polystyrene through an electrostatic interaction.

7. The coated expanded polystyrene of claim 1, wherein the at least one organic compound is provided in an amount sufficient to kill a pest that comes into contact with the coated expanded polystyrene.

8. The coated expanded polystyrene of claim 1, wherein the at least one organic compound is from about 0.01 wt./vol. % to about 1.0 wt./vol. % of the expanded polystyrene.

9. The coated expanded polystyrene of claim 1, wherein the at least one organic compound is from about 0.01 wt/vol. % up to about 0.15 wt/vol. % of the expanded polystyrene.

10. The expanded polystyrene of claim 1, wherein the expanded polystyrene is expandable polystyrene 10 beads.

11. The expanded polystyrene of claim 1, wherein the expanded polystyrene is substantially resistant to pests.

12. The expandable polystyrene of claim 1, wherein the expanded polystyrene is substantially resistant to termites.

13. A method for producing an expanded polystyrene foam comprising:
contacting expandable polystyrene with at least one organic compound in a concentration sufficient to coat an outer surface of the expandable polystyrene when expanded;
mixing the at least one organic compound with the expandable polystyrene to form a mixture; and
exposing the mixture to conditions such that the polystyrene expands to form a coated expanded polystyrene.

14. The method of claim 13, wherein the steps of exposing further comprises providing steam heat and, optionally, pressure to the mixture.

15. The method of claim 13, wherein the at least one organic compound becomes operably bound to the expandable polystyrene when the expandable polystyrene is exposed to conditions that induce expanding.

16. The method of claim 13, wherein the organic compound becomes bound to the expandable polystyrene by an electrostatic interaction polystyrene when the expandable polystyrene is exposed to conditions that induce expanding.

17. The method of claim 13, wherein the organic compound is selected from pesticides, insecticides, termiticides, fungicides, moldicides, bactericides, mildewicides and combinations thereof.

18. The method of claim 13, wherein the at least one organic compound is added in a form selected from a powder, a liquid, an emulsion, and an immiscible concentrate.

19. The method of claim 13, further comprising preparing a molded article from the coated expanded polystyrene.

20. An expanded polystyrene molded article prepared from a method comprising:
contacting expandable polystyrene with at least one organic compound in a concentration sufficient to coat the expandable polystyrene when expanded;
mixing the at least one organic compound with the expandable polystyrene to form a mixture;
exposing the mixture to conditions such that the polystyrene beads expand to form a coated expanded polystyrene; and
preparing a molded article from the coated expanded polystyrene

21. The molded article of claim 20, wherein the organic compound is selected from pesticides, insecticides, termiticide, fungicides, moldicides, bactericides, mildewicides and combinations thereof.

22. The molded article of claim 20, wherein the at least one organic compound is a termiticide.

23. The molded article of claim 20, wherein the at least one organic compound is imidacloprid or imidicloprid containing mixtures.

24. The molded article of claim 20, wherein the at least one organic compound is in a form selected from a powder, a liquid, an emulsion, and an immiscible concentrate.

25. The molded article of claim 20, wherein the molded article is substantially resistant to pests.

26. The molded article of claim 20, wherein the molded article is substantially resistant to termites.

27. The molded article of claim 20, wherein the molded article is selected from polystyrene foam insulation, polystyrene foam board, polystyrene foam packaging, and polystyrene foam coatings.
